(19) United States
(12) Patent Application Publication
(10) Pub. No.: US 2026/0127264 A1
(43) Pub. Date: May 7, 2026

(54) SYSTEM THAT CHANGES PASSWORDS BY IDENTIFYING THE LOCATION OF THE TARGET AREA FOR CHANGE USING A LEARNING OCR ALGORITHM

(71) Applicant: SGA Solutions Co.,Ltd., Uiwang-si (KR)

(72) Inventors: Min Ho CHOI, Anyang-si (KR); Jin Joong Kim, Bucheon-si (KR)

(21) Appl. No.: 19/372,662

(22) Filed: Oct. 29, 2025

(30) Foreign Application Priority Data
Nov. 5, 2024 (KR) 10-2024-0155023

(51) Int. Cl. G06F 21/46; G06F 21/31; G06V 30/19

(52) U.S. Cl. CPC G06F 21/46; G06F 21/31; G06V 30/191; G06V 2201/07

(57) ABSTRACT

A system and method for automatically changing a password for a target user account, comprising: a process-start unit for starting a password-change process for a target user account when at least one among a plurality of user accounts registered as platform members satisfies password-change conditions preset by an administrator account registered as a manager of the platform; an interface-analysis unit configured to log into a pre-linked GUI system using login information for the target user account and to start analyzing, with a stored learning-based OCR algorithm, an interface output through the GUI system to identify the location of the target area required to change a password of the target user account; and a password-change execution unit configured to change the password of the target user account by reflecting change-login information required for changing the password into the identified target area and to change the password based on preset encryption rules.

### FIELD OF THE INVENTION

The present invention relates to a system that changes passwords by identifying, through a learning OCR (optical character recognition) algorithm, the location of a target area for change. More specifically, when at least one among a plurality of user accounts registered as members of a platform satisfies preset password-change conditions, the system logs into a pre-linked GUI system through login information for the user account that satisfied the password-change conditions, starts analyzing an interface output through the GUI system by using a stored learning OCR algorithm to identify the location of a target area required to change the user account's password, and changes the password by reflecting, to the identified location of the target area, change-login information necessary to change the password.

### BACKGROUND OF THE INVENTION

The global password management market was valued at USD 2.35 billion in 2023 and is expected to grow from USD 2.74 billion in 2024 to USD 9.14 billion by 2032, showing a CAGR of 16.2% from 2024 to 2032. A process that implements specific procedures to manage and protect passwords from start to end is called password management, and a centralized password-management procedure has been adopted. The centralized procedure is a method in which a central server manages users' passwords, and it has the advantage of excellent efficiency in managing users' passwords in bulk. However, when, due to a specific event, the central server side needs to change users' passwords, much time and manpower are consumed to change the passwords in bulk.

Accordingly, the industry has been developing various technologies to solve the above problem.

As an example, Korean Registered Patent No. 10-1689848 (“Password management system and password change method using the same”) discloses a technology in which a privileged account user automatically generates a password accessible when connecting to various servers and automatically stores and manages the generated password.

However, the above prior art merely discloses a technology of granting authority to a specific account and storing and managing passwords for each of various servers that the specific account accesses. It does not disclose a technology in which, when at least one among a plurality of user accounts registered as members of a platform satisfies preset password-change conditions, the system logs into a pre-linked GUI system through login information for the user account that satisfied the password-change conditions, starts analyzing an interface output through the GUI system by using a stored learning OCR algorithm to identify the location of a target area required to change the user account's password, and changes the password by reflecting, to the identified location of the target area, change-login information necessary to change the password. Therefore, there is a need for a technology capable of solving this.

### SUMMARY OF THE INVENTION

The present invention was derived to solve the problems of the existing technologies described above. When at least one among a plurality of user accounts registered as members of a platform satisfies preset password-change conditions, the system logs into a pre-linked GUI system through login information for the user account that satisfied the password-change conditions, starts analyzing an interface output through the GUI system by using a stored learning OCR algorithm to identify the location of a target area required to change the user account's password, and changes the password by reflecting, to the identified location of the target area, change-login information necessary to change the password, thereby generally identifying the location of a tab (or area) for changing a user account's password in interfaces provided by the platform and automatically changing the user account's password promptly and conveniently.

According to one embodiment of the present invention, in a system implemented by a computing device including one or more processors and one or more memories storing instructions executable on the processors, which changes passwords by identifying, through a learning OCR algorithm, the location of a target area for change, when at least one among a plurality of user accounts registered as members of a platform satisfies password-change conditions preset by an administrator account registered as a manager of the platform, a process-start unit starts a password-change process for a user account, among the plurality of user accounts, that satisfied the password-change conditions as a target user account; when the password-change process starts, an interface-analysis unit logs into a pre-linked GUI system through login information for the target user account and starts analyzing, by using a stored learning OCR (optical character recognition) algorithm, an interface output through the GUI system to identify, within the interface, the location of a target area required to change a password of the target user account; and when the operation of the interface-analysis unit is completed, a password-change execution unit changes the password of the target user account by reflecting, to the identified location of the target area, change-login information necessary to change the password of the target user account, and changes the password based on preset encryption rules.

Preferably, the process-start unit includes a condition-satisfaction checker configured to start a password-change process targeting the target user account when at least one among the plurality of user accounts satisfies the preset password-change conditions; and a login-information identifier configured to identify, when the password-change process starts, login information of the target user account among a plurality of login information stored in an authentication database.

The password-change conditions are condition information managed by the administrator account and may include, for each of the plurality of user accounts, an expiration condition for a password validity period, a change-request condition received from each user account, and an exceeded login-failure-count condition set for each user account.

Preferably, the interface-analysis unit includes a login progressor configured, as the password-change process starts and identification of login information for the target user account is completed, to analyze a login interface among the interfaces by using the stored learning OCR algorithm and to log into the pre-linked GUI system by inputting the login information into a login tab of the login interface; a change-tab identifier configured, when a main interface among the interfaces is output with the completion of the operation of the login progressor, to analyze the main interface by using the stored learning OCR algorithm and to identify, among a plurality of tabs included in the main interface, a password-change tab for changing the password of the target user account; and a change-interface enterer configured, when identification of the password-change tab is completed, to enter a password-change interface from the main interface through the password-change tab.

Preferably, when entry to the password-change interface is completed by the change-interface enterer, the interface-analysis unit analyzes the password-change interface by using the stored learning OCR algorithm and identifies the location of the target area required to change the password of the target user account. When analyzing the password-change interface using the stored learning OCR algorithm, the location of the target area may be identified through positions of graphical elements implemented within the password-change interface or through text within the password-change interface.

Preferably, the password-change execution unit includes a change-login-information derivation unit configured, when identification of the target area is completed, to derive, based on preset encryption rules, change-login information necessary to change the password of the target user account; and a password-change completer configured, when the operation of the change-login-information derivation unit is completed, to reflect the change-login information to the identified location of the target area to change the password of the target user account.

The target area is an area for inputting information required to change the password of the target user account and may include a current-password area, a new-password area, a confirm-new-password area, and a security-text area.

The stored learning OCR algorithm is, as a learning algorithm that analyzes a login interface provided by another GUI system, a location of a login tab of the login interface provided by another GUI system, a main interface provided by another GUI system, a location of a password-change tab of the main interface provided by another GUI system, a password-change interface provided by another GUI system, and a target area included in the password-change interface provided by another GUI system, learns pattern values derived from analysis results, and is an algorithm for identifying, through the pattern values, the location of the target area into which change-login information is reflected in order to change the password of the target user account.

Through the system that changes passwords by identifying, through a learning OCR algorithm, the location of a target area for change, the location of a tab (or area) required to change a user account's password in interfaces provided by a platform can be generally identified via the learning OCR algorithm, and the user account's password can be automatically changed promptly and conveniently.

### BRIEF DESCRIPTION OF THE DRAWINGS

FIG. 1 is a block diagram for explaining a system that changes passwords by identifying, through a learning OCR algorithm, the location of a target area for change according to an embodiment of the present invention.

FIG. 2 is a block diagram for explaining a password-change request unit of the system that changes passwords by identifying, through a learning OCR algorithm, the location of a target area for change according to an embodiment of the present invention.

FIG. 3 is a block diagram for explaining an interface-analysis unit of the system that changes passwords by identifying, through a learning OCR algorithm, the location of a target area for change according to an embodiment of the present invention.

FIG. 4 is a block diagram for explaining a password-change execution unit of the system that changes passwords by identifying, through a learning OCR algorithm, the location of a target area for change according to an embodiment of the present invention.

FIG. 5 is a drawing for explaining an example of an internal configuration of a computing device according to an embodiment of the present invention.

### DETAILED DESCRIPTION OF THE INVENTION

Hereinafter, various embodiments and/or aspects are disclosed with reference to the drawings. In the following description, for purposes of explanation, numerous specific details are described to aid a general understanding of one or more aspects. However, it will also be recognized by those of ordinary skill in the art of the technical field of the present invention that the aspects can be implemented without these specific details. The following description and the accompanying drawings describe particular exemplary aspects of one or more aspects in detail. However, these aspects are illustrative, and some among various methods in the principles of various aspects may be used, and the descriptions intend to include all such aspects and equivalents thereof.

As used in the present specification, terms such as “embodiment,” “example,” “aspect,” and “illustration” are not necessarily interpreted such that any technology or design described is better than or has an advantage over other technologies or designs.

Also, the terms “comprise” and/or “comprising” mean that a corresponding feature and/or component exists, but are to be understood as not excluding the presence or addition of one or more other features, components, and/or groups thereof.

Also, ordinal terms such as first and second may be used to describe various components, but the components are not limited by the terms. The terms are used only for the purpose of distinguishing one component from another component. For example, without departing from the scope of the present invention, a first component may be named a second component, and similarly, a second component may be named a first component. The term “and/or” includes a combination of a plurality of related listed items or any one among a plurality of related listed items.

Also, in the embodiments of the present invention, unless otherwise defined, all terms used herein, including technical or scientific terms, have the same meaning as commonly understood by those of ordinary skill in the art to which the present invention pertains. Terms defined in commonly used dictionaries are to be interpreted as having meanings consistent with the meanings in the context of relevant technology, and, unless explicitly defined in the embodiments of the present invention, are not to be interpreted in an idealized or overly formal sense.

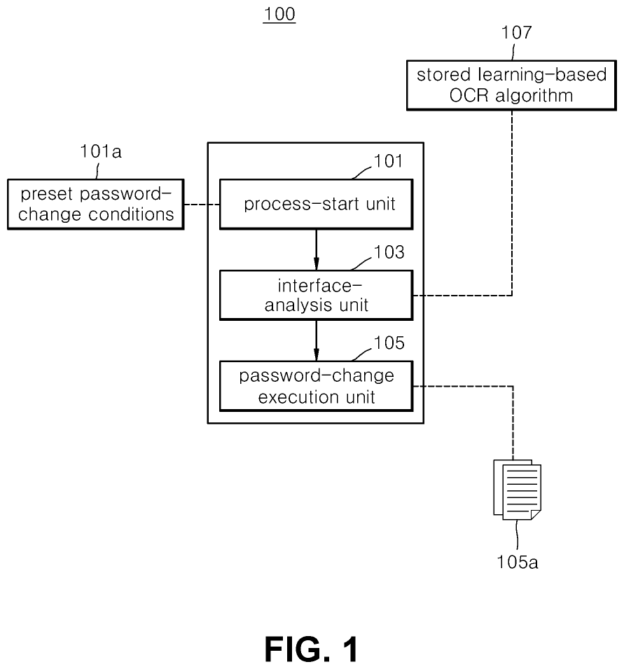

FIG. 1 is a block diagram for explaining a system that changes passwords by identifying, through a learning OCR algorithm, the location of a target area for change according to an embodiment of the present invention.

Referring to FIG. 1, a system 100 that changes passwords by identifying, through a learning OCR algorithm, the location of a target area for change, which is implemented by a computing device including one or more processors and one or more memories storing instructions executable by the processors, may include a process-start unit 101, an interface-analysis unit 103, and a password-change execution unit 105.

According to one embodiment, the process-start unit 101 may, when at least one among a plurality of user accounts registered as members of a platform satisfies password-change conditions preset by an administrator account registered as a manager of the platform, start a password-change process for a target user account, which is the user account that satisfied the password-change conditions.

In relation thereto, the platform may include a social media platform, an e-commerce platform, a game platform, a financial platform, a mobility platform, a healthcare platform, an education platform, a work platform, and a metaverse platform, and is not limited thereto.

According to one embodiment, when at least one among the plurality of user accounts registered as members of the platform satisfies preset password-change conditions, the process-start unit 101 may classify, as the target user account, the user account that satisfied the preset password-change conditions, and may start a password-change process for the target user account.

According to one embodiment, the preset password-change conditions are condition information managed by the administrator account and may include, for each of the plurality of user accounts, an expiration condition for a password validity period, a change-request condition received from each user account, and an exceeded login-failure-count condition set for each user account.

According to one embodiment, when at least one among the plurality of user accounts satisfies at least one among detailed conditions based on the preset password-change conditions, the process-start unit 101 may classify, as the target user account, the user account that satisfied the detailed condition, and may start a password-change process for the target user account.

In relation thereto, the password-change process may be a process for automatically changing the password of the target user account by analyzing, through a stored learning OCR algorithm, an interface output from a GUI system in which the target user account is logged in.

According to one embodiment, when the password-change process starts, the interface-analysis unit 103 may log into a pre-linked GUI system through login information for the target user account and may start analyzing, through a stored learning OCR algorithm, an interface output through the GUI system to identify, within the interface, the location of a target area required to change the password of the target user account.

According to one embodiment, when the password-change process starts, the interface-analysis unit 103 may identify login information (e.g., an account and a password registered in the platform) of the target user account and may log into the GUI system linked with the platform through the identified login information of the target user account.

At this time, the GUI system is a system that provides a visual interface capable of interacting between a user and a computer, may implement graphical elements (e.g., buttons, text boxes, menus, text, etc.) for the platform, and provide them to the user. That is, in the present invention, logging into the GUI system may be identical in meaning to the target user account logging into the platform and outputting an interface in which graphical elements for the platform are implemented.

According to one embodiment, when an interface is output by the GUI system, the interface-analysis unit 103 may start analysis of the output interface by using the stored learning OCR algorithm.

At this time, when the interface-analysis unit 103 proceeds with analysis of the output interface by using the stored learning OCR algorithm, the interface-analysis unit 103 may, through analysis results, identify a target area required to change the password of the target user account and may again identify a location of the identified target area.

In relation thereto, the target area may be an area for inputting information required to change the password of the target user account and may be an area including a current-password area, a new-password area, a confirm-new-password area, and a security-text area.

That is, by analyzing the interface output by using the stored learning OCR algorithm, the interface-analysis unit 103 may identify graphical elements corresponding to respective sub-areas included in the target area among graphical elements included in the interface and may identify the location of the target area.

According to one embodiment, when the operation of the interface-analysis unit 103 is completed, the password-change execution unit 105 may change the password of the target user account by reflecting, to a target area whose location has been identified, change-login information required to change the password of the target user account, and may change the password based on preset encryption rules.

According to one embodiment, as the interface output by using the stored learning OCR algorithm is analyzed and identification of the target area within the interface is completed, the password-change execution unit 105 may reflect change-login information into the identified target area.

In relation thereto, the change-login information may be information including a current password of the target user account and a password to be changed for the target user account.

According to one embodiment, the stored learning OCR algorithm may analyze a login interface provided by another GUI system, a location of a login tab of the login interface provided by another GUI system, a main interface provided by another GUI system, a location of a password-change tab of the main interface provided by another GUI system, a password-change interface provided by another GUI system, and a target area included in the password-change interface provided by another GUI system, and, as a learning algorithm that learns pattern values derived from analysis results, may be an algorithm for identifying, through the pattern values, the location of a target area into which change-login information is reflected in order to change the password of the target user account.

Accordingly, the password-change execution unit 105 may reflect the change-login information into the target area. At this time, a password to be changed for the target user account included in the change-login information may be randomly generated based on encryption rules preset in the platform and may be reflected into the target area. Thereafter, after reflecting the change-login information into the target area, the password-change execution unit 105 may complete a password change for the target user account.

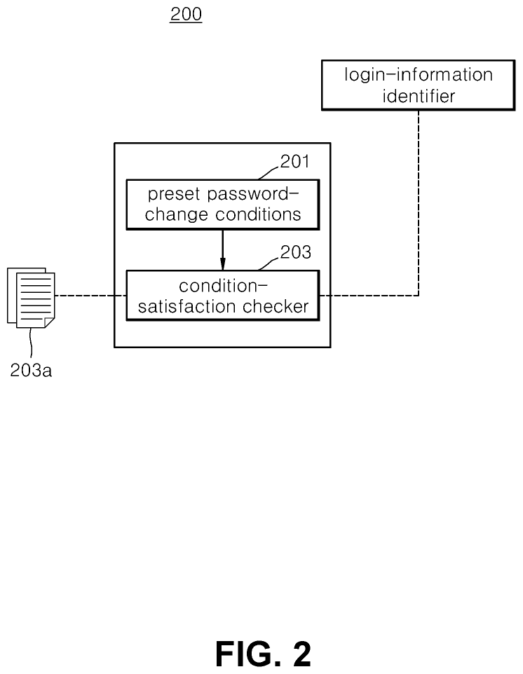

FIG. 2 is a block diagram for explaining a password-change request unit of the system that changes passwords by identifying, through a learning OCR algorithm, the location of a target area for change according to an embodiment of the present invention.

Referring to FIG. 2, a system that changes passwords by identifying, through a learning OCR algorithm, the location of a target area for change (e.g., the system 100 of FIG. 1) implemented by a computing device including one or more processors and one or more memories storing instructions executable by the processors may include a process-start unit 200 (e.g., the process-start unit 101 of FIG. 1).

According to one embodiment, when at least one among a plurality of user accounts registered as members of a platform satisfies password-change conditions preset by an administrator account registered as a manager of the platform, the process-start unit 200 may start a password-change process for a target user account, which is the user account that satisfied the password-change conditions.

According to one embodiment, as a detailed configuration for performing the above function, the process-start unit 200 may include a condition-satisfaction checker 201 and a login-information identifier 203.

According to one embodiment, when at least one among the plurality of user accounts satisfies the preset password-change conditions, the condition-satisfaction checker 201 may start a password-change process targeting the target user account.

According to one embodiment, the condition-satisfaction checker 201 may classify, as the target user account, a user account that satisfies at least one among an expiration condition for a password validity period for each of the plurality of user accounts based on the preset password-change conditions, a change-request condition received from each of the plurality of user accounts, and an exceeded login-failure-count condition set for each of the plurality of user accounts.

According to one embodiment, when classification of the target user account is completed, the condition-satisfaction checker 201 may start a password-change process for automatically changing the password of the target user account.

According to one embodiment, when the password-change process starts, the login-information identifier 203 may identify login information 203a of the target user account among a plurality of login information stored in an authentication database.

According to one embodiment, when the password-change process starts, the login-information identifier 203 may identify, among a plurality of login information stored in the authentication database, login information 203a in which a name, date of birth, and gender of a user of the target user account are matched.

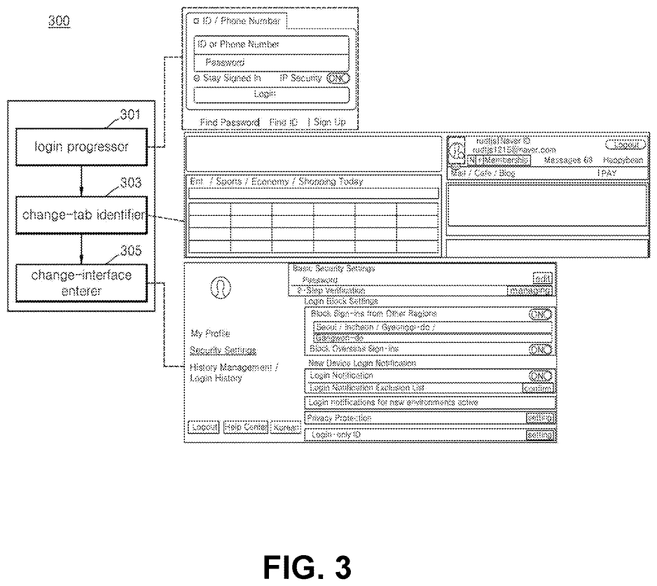

FIG. 3 is a block diagram for explaining an interface-analysis unit of the system that changes passwords by identifying, through a learning OCR algorithm, the location of a target area for change according to an embodiment of the present invention.

Referring to FIG. 3, a system that changes passwords by identifying, through a learning OCR algorithm, the location of a target area for change (e.g., the system 100 of FIG. 1) implemented by a computing device including one or more processors and one or more memories storing instructions executable by the processors may include an interface-analysis unit 300 (e.g., the interface-analysis unit 103 of FIG. 1).

According to one embodiment, when the password-change process starts, the interface-analysis unit 300 may log into a pre-linked GUI system through login information for the target user account and may start analyzing, by using a stored learning OCR algorithm, an interface output through the GUI system to identify, within the interface, the location of a target area required to change the password of the target user account.

According to one embodiment, as a detailed configuration for performing the above function, the interface-analysis unit 300 may include a login progressor 301, a change-tab identifier 303, and a change-interface enterer 305.

According to one embodiment, when the password-change process starts and identification of login information for the target user account is completed, the login progressor 301 may analyze a login interface among the interfaces by using the stored learning OCR algorithm and may log into the pre-linked GUI system by inputting the login information into a login tab of the login interface.

According to one embodiment, as the password-change process for the target user account starts and identification of login information for the target user account among a plurality of login information stored in an authentication database is completed, the login progressor 301 may analyze, through the stored learning OCR algorithm, a login interface among interfaces in which graphical elements are implemented by the GUI system linked with the platform.

According to one embodiment, when identification of login information for the target user account is completed, the login progressor 301 may analyze, by using the stored learning OCR algorithm, a login interface among interfaces including graphical elements implemented by the GUI system, and may identify a login tab (including, for example, an ID input tab, a password input tab, and a security-text input tab) into which the login information is to be reflected.

At this time, the stored learning OCR algorithm may analyze the login interface and identify, among graphical elements included in the login interface, a text box, text, and a menu related to the login tab.

That is, by analyzing the login interface through the stored learning OCR algorithm, the login progressor 301 may identify text by which the login tab included among the graphical elements within the login interface is identifiable and may thus confirm a location of the login tab.

Accordingly, based on the location of the identified login tab, the login progressor 301 may reflect login information of the target user account and proceed with login, thereby causing the GUI system to output a main interface as login is completed from the login interface.

According to one embodiment, when a main interface among the interfaces is output with the completion of the operation of the login progressor 301, the change-tab identifier 303 may analyze the main interface by using the stored learning OCR algorithm and may identify, among a plurality of tabs included in the main interface, a password-change tab for changing the password of the target user account.

According to one embodiment, the change-tab identifier 303 may analyze the main interface by using the stored learning OCR algorithm. At this time, the change-tab identifier 303 may analyze the main interface by using the stored learning OCR algorithm and may identify a password-change tab for changing the password of the target user account.

In relation thereto, the password-change tab may be a tab that needs to be selected to change the password of the target user account.

According to one embodiment, the change-tab identifier 303 may analyze the main interface by using the stored learning OCR algorithm and may identify a location of the password-change tab based on locations of a plurality of tabs each including identified text or may identify a location of the password-change tab by identifying text for password change.

In relation thereto, a principle by which the change-tab identifier 303 may identify a location of the password-change tab based on locations of a plurality of tabs each including identified text or may identify a location of the password-change tab by identifying text for password change is that the stored learning OCR algorithm is a learning algorithm that analyzes a login interface provided by another GUI system, a location of a login tab of the login interface provided by another GUI system, a main interface provided by another GUI system, a location of a password-change tab of the main interface provided by another GUI system, a password-change interface provided by another GUI system, and a target area included in the password-change interface provided by another GUI system, and learns pattern values derived from analysis results.

According to one embodiment, when identification of the password-change tab is completed, the change-interface enterer 305 may enter a password-change interface from the main interface through the password-change tab.

According to one embodiment, when identification of the password-change tab for changing the password of the target user account is completed, the change-interface enterer 305 may enter a password-change interface through the identified password-change tab.

In relation thereto, the password-change interface may be an interface including a target area into which change-login information is reflected to change the password of the target user account.

Accordingly, when entry to the password-change interface is completed by the operation of the change-interface enterer 305, the interface-analysis unit 300 may analyze the password-change interface by using the stored learning OCR algorithm.

In relation thereto, the interface-analysis unit 300 may identify, through results of analyzing the password-change interface by using the stored learning OCR algorithm, a location of a target area required to change the password of the target user account.

At this time, when analyzing the password-change interface by using the stored learning OCR algorithm, the interface-analysis unit 300 may identify a location of the target area through positions of graphical elements implemented in the password-change interface or through text within the password-change interface.

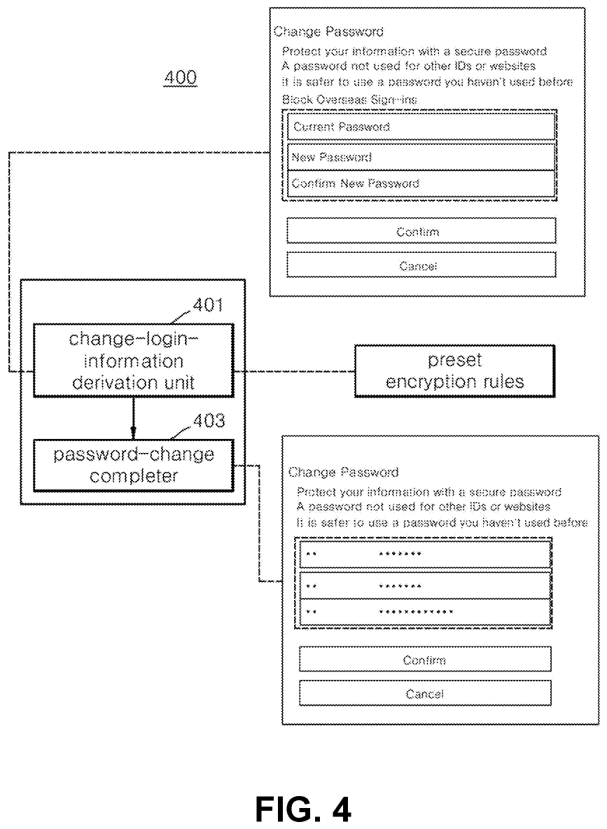

FIG. 4 is a block diagram for explaining a password-change execution unit of the system that changes passwords by identifying, through a learning OCR algorithm, the location of a target area for change according to an embodiment of the present invention.

Referring to FIG. 4, a system that changes passwords by identifying, through a learning OCR algorithm, the location of a target area for change (e.g., the system 100 of FIG. 1) implemented by a computing device including one or more processors and one or more memories storing instructions executable by the processors may include a password-change execution unit 400 (e.g., the password-change execution unit 105 of FIG. 1).

According to one embodiment, when the operation of the interface-analysis unit (e.g., the interface-analysis unit 103 of FIG. 1) is completed, the password-change execution unit 400 may, for a target area whose location has been identified, change the password of the target user account by reflecting change-login information necessary to change the password of the target user account, and may change the password based on preset encryption rules.

According to one embodiment, as a detailed configuration for performing the above function, the password-change execution unit 400 may include a change-login-information derivation unit 401 and a password-change completer 403.

According to one embodiment, when identification of the target area within the password-change interface is completed by the operation of the interface-analysis unit, the change-login-information derivation unit 401 may derive, based on preset encryption rules, new password information among detailed information based on change-login information necessary to change the password of the target user account.

In relation thereto, the preset encryption rules are rules set by a company managing the platform, are information including information on an encryption algorithm, encryption strength, and encryption key length, and may be information that becomes or is used as a standard for changing the password of the target user account.

Accordingly, in order to change the password of the target user account, the change-login-information derivation unit 401 may generate a new password for the target user account based on the preset encryption rules.

According to one embodiment, when generation of a new password for the target user account based on the preset encryption rules is completed, the change-login-information derivation unit 401 may generate change-login information including the new password and an existing password.

According to one embodiment, when the operation of the change-login-information derivation unit 401 is completed, the password-change completer 403 may reflect the change-login information into the identified location of the target area and may change the password of the target user account.

According to one embodiment, when generation of the change-login information is completed by the operation of the change-login-information derivation unit 401, the password-change completer 403 may reflect a current password into a current-password area of the target area and may reflect a new password into a new-password area and a confirm-new-password area. At this time, when a security-text area exists in the target area, the password-change completer 403 may, by identifying text within the password-change interface by using the stored learning OCR algorithm, reflect security text corresponding to the identified text into the security-text area.

Accordingly, in the present invention, when at least one among a plurality of user accounts registered as members of a platform managed by an individual or an organization satisfies password-change conditions, a password-change process for automatically changing the password of a user account that satisfied the password-change conditions is carried out by analyzing an interface through a learning OCR algorithm, so that, in interfaces provided by various platforms, the location of a tab (or area) for changing the user account's password can be generally identified, and the user account's password can be changed promptly and conveniently.

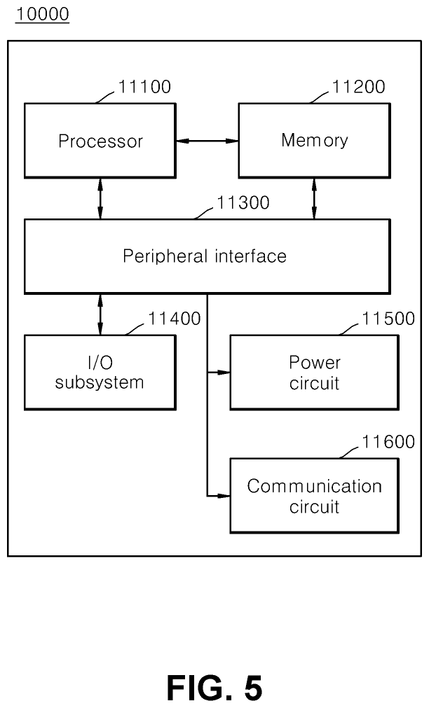

FIG. 5 is a drawing for explaining an example of an internal configuration of a computing device according to an embodiment of the present invention.

FIG. 5 illustrates an example of an internal configuration of a computing device according to an embodiment of the present invention, and in the following description, unnecessary descriptions that overlap with the descriptions of FIGS. 1 to 4 described above will be omitted.

As illustrated in FIG. 5, a computing device 10000 may include at least one processor 11100, a memory 11200, a peripheral interface 11300, an I/O subsystem 11400, a power circuit 11500, and a communication circuit 11600. In this case, the computing device 10000 may correspond to a user terminal connected to a haptic interface (A) or may correspond to the above-described computing device (B).

The memory 11200 may include, for example, high-speed random access memory, magnetic disk, SRAM (static random access memory), DRAM (dynamic random access memory), ROM (read-only memory), flash memory, or non-volatile memory. The memory 11200 may include software modules, instruction sets, or various data necessary for the operation of the computing device 10000.

In this case, access by other components such as the processor 11100 or the peripheral interface 11300 to the memory 11200 may be controlled by the processor 11100.

The peripheral interface 11300 may couple input and/or output peripherals of the computing device 10000 to the processor 11100 and the memory 11200. The processor 11100 may execute software modules or instruction sets stored in the memory 11200 to perform various functions for the computing device 10000 and to process data. The I/O subsystem 11400 may couple various input/output peripherals to the peripheral interface 11300. For example, the I/O subsystem 11400 may include a controller for coupling peripherals such as a monitor, keyboard, mouse, printer, or, as necessary, a touch screen or sensors, to the peripheral interface 11300. In another aspect, input/output peripherals may be coupled to the peripheral interface 11300 without passing through the I/O subsystem 11400.

The power circuit 11500 may supply power to all or part of components of the device. For example, the power circuit 11500 may include a power management system, one or more power sources such as a battery or AC, a charging system, a power failure detection circuit, a power converter or inverter, a power status indicator, or any other components for power generation, management, and distribution.

The communication circuit 11600 may enable communication with another computing device by using at least one external port. Alternatively, as described above, as necessary, the communication circuit 11600 may include an RF circuit and may enable communication with another computing device by transmitting and receiving RF signals, also known as electromagnetic signals.

Such an embodiment of FIG. 5 is only an example of the computing device 10000, and the computing device 10000 may omit some components illustrated in FIG. 5, may further include additional components not illustrated in FIG. 5, or may have a configuration or arrangement in which two or more components are combined. For example, a computing device for a communication terminal in a mobile environment may further include, in addition to the components illustrated in FIG. 5, a touch screen or sensors, and the communication circuit 11600 may include a circuit for RF communication for various communication methods (Wi-Fi, 3G, LTE, Bluetooth, NFC, Zigbee, etc.). Components includable in the computing device 10000 may be implemented as hardware including one or more integrated circuits specialized for signal processing or applications, software, or a combination of hardware and software.

Methods according to embodiments of the present invention may be implemented as program instructions that can be executed through various computing devices and recorded on a computer-readable medium. In particular, a program according to an embodiment may be composed of a PC-based program or an application dedicated to a mobile terminal. An application to which the present invention is applied may be installed in a user terminal through a file provided by a file distribution system. For example, the file distribution system may include a file transmission unit (not shown) that transmits the file in response to a request from the user terminal.

The above-described devices may be implemented as hardware components, software components, and/or combinations of hardware and software components. For example, the devices and components described in the embodiments may be implemented by using one or more general-purpose computers or special-purpose computers, such as a processor, a controller, an ALU, a DSP, a microcomputer, an FPGA, a PLU, a microprocessor, or any other device that can execute and respond to instructions. The processing device may execute an operating system (OS) and one or more software applications performed on the operating system. Also, in response to execution of software, the processing device may access, store, manipulate, process, and generate data. For convenience of understanding, in some cases a single processing device is described, but those skilled in the art will appreciate that the processing device may include a plurality of processing elements and/or a plurality of types of processing elements. For example, the processing device may include a plurality of processors or may include one processor and one controller. Also, other processing configurations, such as a parallel processor, are possible.

Software may include a computer program, code, and instructions, or one or more combinations thereof, and may configure the processing device to operate as desired or may command the processing device, independently or collectively. Software and/or data may be embodied, permanently or temporarily, in any type of machine, component, physical device, virtual equipment, computer storage medium, or device, in order to be interpreted by a processing device or to provide instructions or data to the processing device. Software may be distributed across network-connected computing devices, and may be stored or executed in a distributed manner. Software and data may be stored on one or more computer-readable recording media.

A method according to an embodiment may be implemented as program instructions that can be executed through various computer means and recorded on a computer-readable medium. The computer-readable medium may include program instructions, data files, and data structures alone or in combination. Program instructions recorded on the medium may be those specially designed and configured for the embodiments or those known to be usable by computer software artisans. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions such as ROMs, RAMs, and flash memories. Examples of program instructions include machine code generated by a compiler and higher-level language code executable by a computer using an interpreter. The above hardware devices may be configured to operate as one or more software modules to perform operations of the embodiments, and vice versa.

Although embodiments have been described with reference to limited embodiments and drawings, various modifications and variations are possible to those skilled in the art based on the above description. For example, the described technologies may be performed in an order different from the described method, and/or components of systems, structures, devices, and circuits may be combined or combined in forms different from the described method, or may be replaced with other components or equivalents, and an appropriate result may still be achieved. Therefore, other implementations, other embodiments, and those equivalent to the claims below are within the scope of the claims described below.

What is claimed is:

1. A system implemented by one or more processors and one or more memories storing instructions executable by the processors, changing passwords by identifying the location of the target area for change using a learning OCR algorithm, the system comprising:
a process-start unit configured to start a password-change process for a target user account when at least one among a plurality of user accounts registered as platform members satisfies password-change conditions preset by an administrator account registered as a manager of the platform;
an interface-analysis unit configured, when the password-change process starts, to log into a pre-linked GUI system using login information for the target user account and to start analyzing, with a stored learning-based OCR algorithm, an interface output through the GUI system to identify, within the interface, the location of the target area required to change a password of the target user account; and
a password-change execution unit configured, upon completion of operation of the interface-analysis unit, to change the password of the target user account by reflecting change-login information required for changing the password into the identified target area and to change the password based on preset encryption rules.

2. The system of claim 1, wherein the process-start unit comprises: a condition-satisfaction checker configured to start the password-change process targeting the target user account when at least one of the plurality of user accounts satisfies the preset password-change conditions; and a login-information identifier configured, when the password-change process starts, to identify login information of the target user account among multiple login records stored in an authentication database.

3. The system of claim 2, wherein the password-change conditions are condition information managed by the administrator account and include, an expiration condition for a password validity period for each user account among the plurality, a change-request condition received from each user account, and an exceeded login-failure-count condition set for each user account.

4. The system of claim 1, wherein the interface-analysis unit comprises: a login-progressor configured, upon completion of identification of the target user account's login information after the password-change process starts, to analyze a login interface among the interfaces using the stored learning-based OCR algorithm and to input the login information into a login tab of the login interface to log into the pre-linked GUI system; a change-tab identifier configured, when a main interface is output upon completion of operation of the login-progressor, to analyze the main interface using the stored learning-based OCR algorithm and to identify, among multiple tabs included in the main interface, a password-change tab for changing the password of the target user account; and a change-interface enterer configured, upon completion of identification of the password-change tab, to enter a password-change interface from the main interface via the password-change tab.

5. The system of claim 4, wherein, when entry into the password-change interface is completed by the change-interface enterer, the interface-analysis unit is configured to analyze the password-change interface using the stored learning-based OCR algorithm and to identify the location of the target area required to change the password of the target user account, and wherein, during analysis of the password-change interface, the location of the target area is identified based on positions of graphical elements implemented in the password-change interface or based on text within the password-change interface.

6. The system of claim 1, wherein the password-change execution unit comprises: a change-login-information derivation unit configured, upon completion of identification of the target area, to derive, based on preset encryption rules, change-login information required to change the password of the target user account; and a password-change completer configured, upon completion of operation of the change-login-information derivation unit, to reflect the change-login information into the identified target area to change the password of the target user account.

7. The system of claim 6, wherein the target area is an input area for information required to change the password of the target user account and includes a current-password area, a new-password area, a confirm-new-password area, and a security-text area.

8. The system of claim 1, wherein the stored learning-based OCR algorithm is a learning algorithm that analyzes, across different GUI systems, login interfaces, positions of login tabs within the login interfaces, main interfaces, positions of password-change tabs within the main interfaces, password-change interfaces, and target areas included in the password-change interfaces, learns pattern values derived from analysis results, and identifies, using the pattern values, the location of the target area into which change-login information is to be reflected to change the password of the target user account.
